(19) United States
(12) Patent Application Publication
(10) Pub. No.: US 2025/0379473 A1
(43) Pub. Date: Dec. 11, 2025

(54) WIRELESS POWER TRANSFER CIRCUIT

(71) Applicant: Realtek Semiconductor Corp., HsinChu (TW)

(72) Inventors: Kiat Seng Yeo, Singapore (SG); Bharatha Kumar Thangarasu, Singapore (SG); Ka-Un Chan, HsinChu (TW); Rong-Fu Yeh, HsinChu (TW)

(73) Assignee: Realtek Semiconductor Corp., HsinChu (TW)

(21) Appl. No.: 19/172,682

(22) Filed: Apr. 8, 2025

Related U.S. Application Data
(60) Provisional application No. 63/656,608, filed on Jun. 6, 2024.

(51) Int. Cl. H02J 50/20; H02J 7/00; H02J 7/34; H02J 50/00; H02M 1/00; H02M 1/44

(52) U.S. Cl. CPC H02J 50/20; H02J 7/00308; H02J 7/345; H02J 50/001; H02M 1/007; H02M 1/44; H02J 2207/20; H02J 2207/50

(57) ABSTRACT

A WPT circuit is provided. The WPT circuit includes a radio frequency (RF) front-end circuit, a power path circuit, an auxiliary path circuit, a control circuit and a switch circuit. The RF front-end circuit is configured to convert a single-end input signal received by an antenna into differential input signals. The power path circuit is configured to convert the differential input signals into a direct current (DC) output voltage. The auxiliary path circuit is configured to convert the differential input signals into a DC supply voltage. The control circuit is configured to utilize the DC supply voltage as a power source and generate a control signal according to the DC output voltage. The switch circuit is configured to determine whether to conduct the DC output voltage to the energy storage element according to the control signal.

### CROSS REFERENCE TO RELATED APPLICATIONS

This application claims the benefit of U.S. Provisional Application No. 63/656,608,filed on Jun. 6, 2024. The content of the application is incorporated herein by reference.

### BACKGROUND OF THE INVENTION

### 1. Field of the Invention

The present invention is related to wireless charging for mobile devices, and more particularly, to a wireless power transfer (WPT) circuit which transfers far-field radio frequency (RF) energy to an energy storage element.

### 2. Description of the Prior Art

Wireless charging technologies become popular recently, which enables mobile devices being charged without wired connection, thereby allowing these devices be completely mobile. In order to achieve energy harvesting of radio frequency (RF) power, a power transfer system converts the RF power into charges stored in a storage element. However, loading caused by the storage element affects transfer efficiency of transferring the RF power, especially when the RF power is low. More particularly, the power transfer system is a self-powered system, which utilizes energy obtained by converting the RF power into direct current (DC) voltages to power up the internal supporting circuit. Thus, when the loading is large and the RF power is low, an output voltage from the power transfer system to the storage element drops, and internal supporting circuits of the power transfer system will eventually be powered down. Furthermore, if the internal supporting circuits are designed based on requirements of large loading and low RF power, components within the internal supporting circuits may have risks of being damaged when the RF power is too high and making supply voltages of the internal supporting circuits exceed acceptable ranges.

Thus, there is a need for a novel architecture of the power transfer system, which can achieve better overall performance of transferring far-field wireless power to the storage element under the condition where the far-field wireless power is low in comparison with the related art.

### SUMMARY OF THE INVENTION

An objective of the present invention is to provide a wireless power transfer (WPT) circuit, which prevent internal supporting circuits within the WPT circuit from being affected by loading of a storage element of the WPT circuit, allowing the internal supporting circuits to be optimized for handling low input power conditions.

At least one embodiment of the present invention is to provide a WPT circuit. The WPT circuit comprises a radio frequency (RF) front-end circuit, at least one power path circuit, an auxiliary path circuit, a control circuit and a switch circuit, where the at least one power path circuit is coupled to the RF front-end circuit, the auxiliary path circuit is coupled to the RF front-end circuit, the control circuit is coupled to the auxiliary path circuit, and the switch circuit is coupled between an output terminal of the at least one power path circuit and an energy storage element. In particular, the RF front-end circuit is configured to convert a single-end input signal received by an antenna into differential input signals. The at least one power path circuit is configured to convert the differential input signals respectively received by a first input terminal and a second input terminal of the at least one power path circuit into a direct current (DC) output voltage. The auxiliary path circuit is configured to convert the differential input signals respectively received by a first input terminal and a second input terminal of the auxiliary path circuit into a DC supply voltage. The control circuit is configured to utilize the DC supply voltage as a power source and generate a control signal according to the DC output voltage. The switch circuit is configured to determine whether to conduct the DC output voltage to the energy storage element according to the control signal.

The WPT circuit provided by the embodiment of the present invention utilizes an independent path to provide a supply voltage for internal supporting circuit(s) within the WPT circuit. As the independent path does not drive the loading of the energy storage element, the independent path can be optimized under low power and small loading conditions, enabling the internal supporting circuit(s) to properly operate in various conditions (e.g. the condition of low RF powers). In addition, the embodiment of the present invention does not greatly increase additional costs. Thus, the present invention can improve performance of far-field power transfer without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless power transfer system according to an embodiment of the present invention.

FIG. 2 is a diagram illustrating a wireless power transfer system according to another embodiment of the present invention.

FIG. 3 is a diagram illustrating a radio frequency (RF) front-end circuit according to an embodiment of the present invention.

FIG. 4 is a diagram illustrating a first example of a rectifier circuit according to an embodiment of the present invention.

FIG. 5 is a diagram illustrating a second example of a rectifier circuit according to an embodiment of the present invention.

FIG. 6 is a diagram illustrating a third example of a rectifier circuit according to an embodiment of the present invention.

FIG. 7 is a diagram illustrating a control circuit according to an embodiment of the present invention.

FIG. 8 is a diagram illustrating operations of a hysteresis comparator according to an embodiment of the present invention.

FIG. 9 is a diagram illustrating details of a reference generator shown in FIG. 7 according to an embodiment of the present invention.

FIG. 10 is a diagram illustrating details of an amplifier shown in FIG. 7 according to an embodiment of the present invention.

### DETAILED DESCRIPTION

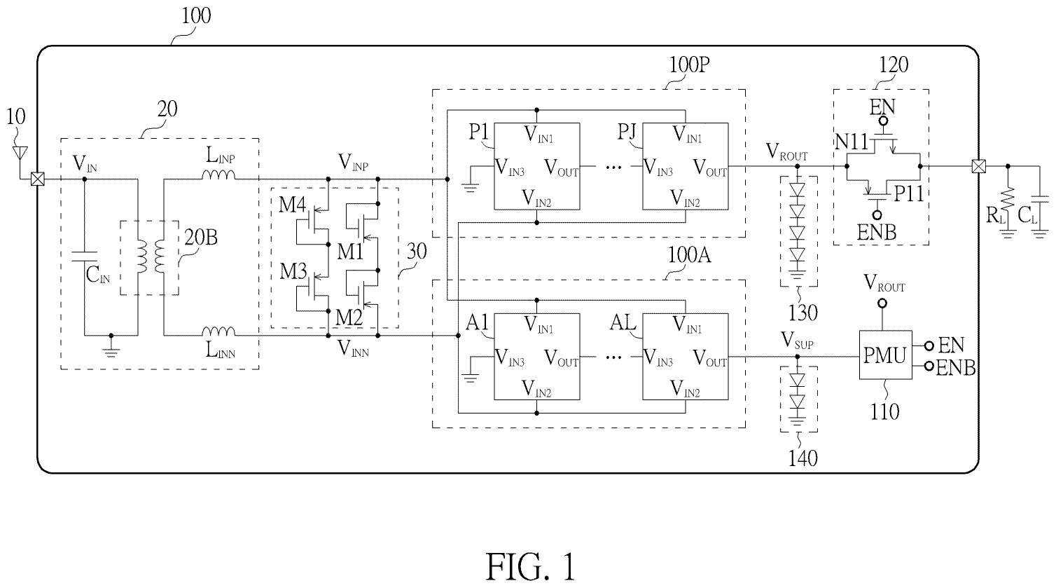

FIG. 1 is a diagram illustrating a wireless power transfer (WPT) system such as a WPT circuit 100 according to an embodiment of the present invention, wherein the WPT circuit 100 is coupled between an antenna 10 and an energy storage element (which is indicated by a load resistor R_{L} and a load capacitor C_{L}), and the WPT circuit 100 is configured to transfer a radio frequency (RF) input power of a RF input signal V_{IN} received by the antenna to the energy storage element. As shown in FIG. 1, the WPT circuit 100 may comprise an RF front-end circuit 20, at least one power path circuit such as a main power path circuit 100P, an auxiliary path circuit 100A, a control circuit such as a power management unit (PMU) 110, and a switch circuit 120, where the main power path circuit 100P is coupled to the RF front-end circuit 20, the auxiliary path circuit 100A is coupled to the RF front-end circuit 20, the PMU 110 is coupled to the auxiliary path circuit 100A, and the switch circuit 120 is coupled between an output terminal of the main power path circuit 100P and the energy storage element (e.g. the load capacitor C_{L}). In this embodiment, the RF front-end circuit 20 is configured to convert a single-end input signal such as the RF input signal V_{IN} received by the antenna 10 into differential input signals such as input signals V_{INP} and V_{INN}, where the main power path circuit 100P is configured to convert the input signals V_{INP} and V_{INN} respectively received by a first input terminal and a second input terminal of the main power path circuit 100P into a direct current (DC) output voltage V_{ROUT}, and the auxiliary path circuit 100A is configured to convert the input signals V_{INP} and V_{INN} respectively received by a first input terminal and a second input terminal of the auxiliary path circuit 100A into a DC supply voltage V_{SUP}. With this configuration, both the main power path circuit 100P and the auxiliary path circuit 100A perform full-wave rectification to generate the DC output voltage V_{ROUT} and the DC supply voltage V_{SUP}. In addition, the PMU 110 is configured to utilize the DC supply voltage V_{SUP} as a power source and generate a control signal EN according to the DC output voltage V_{ROUT}. The switch circuit 120 is configured to determine whether to conduct the DC output voltage V_{ROUT} to the energy storage element such as the load capacitor C_{L} according to the control signal EN.

In this embodiment, the RF front-end circuit 20 may comprise an input capacitor C_{IN}, a balanced-to-unbalanced (balun) transformer 20B and a matching network such as inductors L_{INP} and L_{INN}, where the input capacitor C_{IN} is coupled between the antenna 10 and a reference voltage such as an alternating current (AC) ground voltage, an input terminal of the balun transformer 20B is coupled to the antenna 10, output terminals of the balun transformer 20B is coupled to the matching network (e.g. coupled to the inductors L_{INP} and L_{INN}, respectively), and the matching network is coupled between the balun transformer 20B and the at least one power path circuit (e.g. the main power path circuit 100P). More particularly, the inductor L_{INP} of the matching network is coupled between a first output terminal of the balun transformer 20B and the first input terminal of the main power path circuit 100P (i.e. between the first output terminal of the balun transformer 20B and the first input terminal of the auxiliary path circuit 100A), and the inductor L_{INN} of the matching network is coupled between a second output terminal of the balun transformer 20B and the second input terminal of the main power path circuit 100P (i.e. between the second output terminal of the balun transformer 20B and the second input terminal of the auxiliary path circuit 100A). In this embodiment, the balun transformer 20B is configured to convert the RF input signal V_{IN} into the input signals V_{INP} and V_{INN}, and the matching network is configured to transmit the input signals V_{INP} and V_{INN} to the at least one power path circuit (e.g. the main power path circuit 100P) minimized return loss. More particularly, the inductor L_{INP} of the matching network is configured to transmit the input signal V_{INP} to the main power path circuit 100P and the auxiliary path circuit 100A, and the inductor L_{INN} of the matching network is configured to transmit the input signal V_{INN} to the main power path circuit 100P and the auxiliary path circuit 100A.

In this embodiment, the WPT circuit 100 may further comprise a RF limiter 30, where the RF limiter is coupled between the first input terminal and the second input terminal of the main power path circuit 100P (i.e. the first input terminal and the second input terminal of the auxiliary path circuit 100A), and is configured to limit a voltage difference between the input signals V_{INP} and V_{INN}. As shown in FIG. 1, the RF limiter 30 may comprise at least one first diode-connected transistor such as transistors M1 and M2 and at least one second diode-connected transistors such as transistors M3 and M4, where a gate terminal and a drain terminal of the transistor M1 is coupled to the first input terminal of the main power path circuit 100P, a gate terminal and a drain terminal of the transistor M2 is coupled to a source terminal of the transistor M1, a source terminal of the transistor M2 is coupled to the second input terminal of the main power path circuit 100P, a gate terminal and a drain terminal of the transistor M3 is coupled to the second input terminal of the main power path circuit 100P, a gate terminal and a drain terminal of the transistor M4 is coupled to a source terminal of the transistor M3, a source terminal of the transistor M4 is coupled to the first input terminal of the main power path circuit 100P.

As shown in FIG. 1, the main power path circuit 100P may comprise multiple cascaded rectifier circuits such as J rectifier circuits P1, . . . and PJ, where J may be a positive integer. In addition, the auxiliary path circuit 100A may comprise multiple cascaded rectifier circuits such as L rectifier circuits A1, . . . and AL, where L may be a positive integer. Note that each of the J rectifier circuits P1, . . . and PJ has a first input terminal such as an input terminal V_{IN1} (which receives the input signal V_{INP}), a second input terminal such as an input terminal V_{IN2} (which receives the input signal V_{INN}), a third input terminal such as an input terminal V_{IN3}, and an output terminal V_{OUT}. For a certain rectifier circuit within the main power path circuit 100P, the input terminal V_{IN3} of this rectifier circuit is coupled to the output terminal V_{OUT} of a previous rectifier circuit, and the output terminal V_{OUT} of this rectifier circuit is coupled to the input terminal V_{IN3} of a next rectifier circuit, where the input terminal V_{IN3} of a first rectifier circuit within the main power path circuit 100P (i.e. the rectifier circuit P1) is coupled to a reference voltage such as the AC ground voltage, and the output terminal V_{OUT} of a last rectifier circuit within the main power path circuit 100P (i.e. the rectifier circuit PJ) is configured to output the DC output voltage V_{ROUT}. In addition, each of the L rectifier circuits A1, . . . and AL has a first input terminal such as the input terminal V_{IN1} (which receives the input signal V_{INP}), a second input terminal such as the input terminal V_{IN2} (which receives the input signal V_{INN}), a third input terminal such as the input terminal V_{IN3}, and the output terminal V_{OUT}. For a certain rectifier circuit within the auxiliary path circuit 100A, the input terminal V_{IN3} of this rectifier circuit is coupled to the output terminal V_{OUT} of a previous rectifier circuit, and the output terminal V_{OUT} of this rectifier circuit is coupled to the input terminal V_{IN3} of a next rectifier circuit, where the input terminal V_{IN3} of a first rectifier circuit within the auxiliary path circuit 100A (i.e. the rectifier circuit A1) is coupled to a reference voltage such as the AC ground voltage, and the output terminal V_{OUT} of a last rectifier circuit within the auxiliary path circuit 100A (i.e. the rectifier circuit AL) is configured to output the DC supply voltage V_{SUP}. According to this architecture, a whole of the input terminals V_{IN1} of the J rectifier circuits P1, . . . and PJ may be regarded as the first input terminal of the main power path circuit 100P mentioned above, and a whole of the input terminals V_{IN2} of the J rectifier circuits P1, . . . and PJ may be regarded as the second input terminal of the main power path circuit 100P mentioned above. A whole of the input terminals V_{IN1} of the L rectifier circuits A1, . . . and AL may be regarded as the first input terminal of the auxiliary path circuit 100A mentioned above, and a whole of the input terminals V_{IN2} of the L rectifier circuits A1, . . . and AL may be regarded as the second input terminal of the auxiliary path circuit 100A mentioned above. Each of the J rectifier circuits P1, . . . and PJ or each of the L rectifier circuits A1, . . . and AL is configured to convert the RF input signal V_{IN} (more particularly, the differential input signals {V_{INP}, V_{INN}}) into a DC voltage, and further serve as a voltage booster circuit which increases a voltage level of an output voltage based on a previous rectifier circuit thereof to achieve a better efficiency. It should be noted that the number of the multiple cascaded rectifier circuits within the main power path circuit 100P may be determined according to tradeoff between a maximum of the DC output voltage V_{ROUT} and sensitivity of the WPT circuit 100 (e.g. a dynamic range of the WPT circuit 100).

In some embodiment, the architecture of each rectifier circuit within the main power path circuit 100P may be the same as the architecture of each rectifier circuit within the auxiliary path circuit 100A, where detailed parameters (e.g. components types with different threshold voltages, component dimensions) of each rectifier circuit within the main power path circuit 100P may be determined (e.g. optimized for power transfer efficiency) according to the output load (e.g. the capacitor C_{L} and the resistor R_{L}) introduced by the energy storage element, and detailed parameters (e.g. components types with different threshold voltages, component dimensions) of each rectifier circuit within the auxiliary path circuit 100A may be determined (e.g. optimized for low power or low voltage operations) according to an output load (e.g. a load introduced by the PMU 110, which is typically much smaller than the capacitor C_{L}) of the auxiliary path circuit 100A. In some embodiment, the architecture of each rectifier circuit within the main power path circuit 100P may be different from the architecture of each rectifier circuit within the auxiliary path circuit 100A, in order to allow each of the main power path circuit 100P and the auxiliary path circuit 100A to be implemented by optimized architecture independently.

As mentioned above, the main power path circuit 100P is coupled to the RF front-end circuit 20 and the switch circuit 120, and is configured to convert the input signals V_{INP} and V_{INN} into the DC output voltage V_{ROUT}. In this embodiment, when the DC output voltage V_{ROUT} is pulled up to be greater than a first threshold level such as a threshold level V_{H}, the control signal EN generated by the PMU 110 is switched to a first state (e.g. a voltage level VDD corresponding to a logic value “1”) to make the switch circuit 120 be turned on, in order to conduct the DC output voltage V_{ROUT} to the energy storage element (e.g. the load capacitor C_{L}). When the DC output voltage V_{ROUT} is pulled down to be less than a second threshold level such as a threshold level V_{L}, the control signal EN generated by the PMU 110 is switched to a second state (e.g. a voltage level VSS corresponding to a logic value “0”) to make the switch circuit 120 be turned off, in order to prevent the DC output voltage V_{ROUT} from being transmitted to the energy storage element (e.g. the load capacitor C_{L}).

In this embodiment, the WPT circuit 100 may further comprise an over-voltage protection (OVP) circuit 130, where the OVP circuit 130 is coupled to the output terminal of the main power path circuit 100P, and is configured to limit a voltage level of the DC output voltage V_{ROUT}. More particularly, the OVP circuit 130 may comprise M stacked diodes, where M is a positive integer and is not limited to the number shown in FIG. 1. When a cut-in voltage of each of the M stacked diodes is V_{CUTIN1}, the voltage level of the DC output voltage V_{ROUT} can be limited below (M×V_{CUTIN1}). In addition, the WPT circuit 100 may further comprise an OVP circuit 140, where the OVP circuit 140 is coupled to the output terminal of the auxiliary path circuit 100A, and is configured to limit a voltage level of the DC supply voltage V_{SUP}. More particularly, the OVP circuit 140 may comprise N stacked diodes, where N is a positive integer and is not limited to the number shown in FIG. 1. When a cut-in voltage of each of the N stacked diodes is V_{CUTIN2}, the voltage level of the DC supply voltage V_{SUP} can be limited below (N×V_{CUTIN2}).

In order to improve efficiency and mitigating DC voltage drop from an output of the main power path circuit 100P to the energy storage element, the switch circuit 120 may be implemented by a transmission gate, which comprises a N-type transistor N11 and a P-type transistor P11, where a source terminal of the N-type transistor N11 is coupled to a drain terminal of the P-type transistor P11, a drain terminal of the N-type transistor N11 is coupled to a source terminal of the P-type transistor P11, and gate terminals of the N-type transistor and the P-type transistor are controlled by the control signal and an inverted control signal ENB of the control signal EN, respectively. Furthermore, in order to mitigate an body effect of the N-type transistor N11 and the P-type transistor P11, a body terminal of the N-type transistor N11 is coupled to the source terminal of the N-type transistor N11, and a body terminal of the P-type transistor P11 is coupled to the source terminal of the P-type transistor P11. Thus, when the control signal EN generated by the PMU 110 is switched to the first state (e.g. the voltage level VDD corresponding to the logic value “1”), the inverted control signal ENB may be switched to the second state (e.g. the voltage level VSS corresponding to the logic value “0”), and both the N-type transistor N11 and the P-type transistor P11 may be turned on to conduct the DC output voltage V_{ROUT} to the energy storage element (e.g. the load capacitor C_{L}). When the control signal EN generated by the PMU 110 is switched to the second state (e.g. the voltage level VSS corresponding to the logic value “0”), the inverted control signal ENB may be switched to the first state (e.g. the voltage level VDD corresponding to the logic value “1”), and both the N-type transistor N11 and the P-type transistor P11 may be turned off to prevent the DC output voltage V_{ROUT} from being transmitted to the energy storage element (e.g. the load capacitor C_{L}).

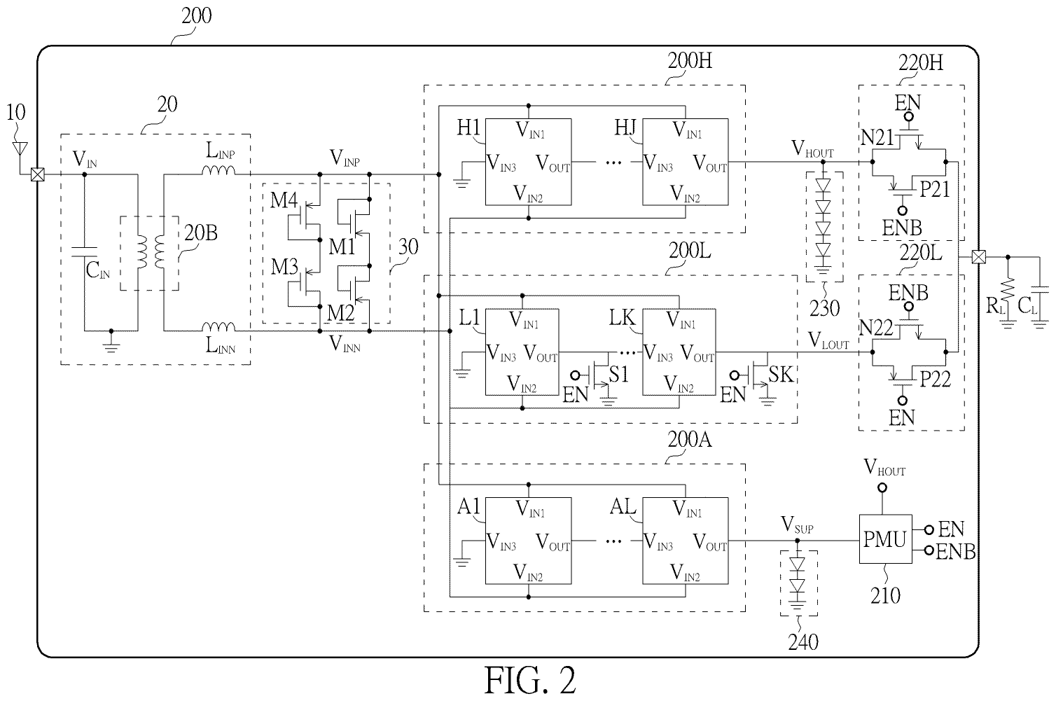

FIG. 2 is a diagram illustrating a WPT system such as a WPT circuit 200 according to another embodiment of the present invention, wherein the WPT circuit 200 is coupled between the antenna 10 and the energy storage element (which is indicated by the load resistor R_{L} and the load capacitor C_{L}), and the WPT circuit 200 is configured to transfer the RF input power of the RF input signal V_{IN} received by the antenna 10 to the energy storage element. As shown in FIG. 2, the WPT circuit 200 may comprise the RF front-end circuit 20, at least one power path circuit such as a high power path circuit 200H and a low power path circuit 200L, an auxiliary path circuit 200A, a control circuit such as a PMU 210, and switch circuits 220H and 220L, where the high power path circuit 200H and the low power path circuit 200L are coupled to the RF front-end circuit 20, the auxiliary path circuit 200A is coupled to the RF front-end circuit 20, the PMU 210 is coupled to the auxiliary path circuit 200A, and the switch circuit 220H is coupled between an output terminal of the high power path circuit 200H and the energy storage element (e.g. the load capacitor C_{L}), and the switch circuit 220L is coupled between an output terminal of the low power path circuit 200L and the energy storage element (e.g. the load capacitor C_{L}). Similar to the embodiment of FIG. 1, the RF front-end circuit 20 is configured to convert the RF input signal V_{IN} received by the antenna 10 into the input signals V_{INP} and V_{INN}. In this embodiment, the high power path circuit 200H is configured to convert the input signals V_{INP} and V_{INN} respectively received by a first input terminal and a second input terminal of the high power path circuit 200H into a DC output voltage V_{HOUT}, and the low power path circuit 200L is configured to convert the input signals V_{INP} and V_{INN} respectively received by a first input terminal and a second input terminal of the low power path circuit 200L into a DC output voltage V_{LOUT}, where the auxiliary path circuit 200A is configured to convert the input signals V_{INP} and V_{INN} respectively received by a first input terminal and a second input terminal of the auxiliary path circuit 200A into the DC supply voltage V_{SUP}. In addition, the PMU 210 is configured to utilize the DC supply voltage V_{SUP} as a power source and generate the control signal EN according to the DC output voltage V_{HOUT}. The switch circuit 220H and the switch circuit 220L are configured to determine whether to conduct the DC output voltage V_{HOUT} or the DC output voltage V_{LOUT} to the energy storage element such as the load capacitor C_{L} according to the control signal EN.

It should be noted that operations of the RF front-end circuit 20 and the RF limiter 30 within the WPT circuit 200 shown in FIG. 2 are identical to operations of the RF front-end circuit 20 and the RF limiter 30 within the WPT circuit 100 shown in FIG. 1, related details will not be repeated here for brevity. In addition, the matching network within the RF front-end circuit 20 is not limited to that shown in FIG. 1 and FIG. 2. For example, the matching network may be implemented by T-network as shown in FIG. 3, which is a diagram illustrating a RF front-end circuit 300 according to an embodiment of the present invention. In comparison with the RF front-end circuit 20, the front-end circuit 300 shown in FIG. 3 utilizes a first T-network (which is formed by inductors L11 and L12 coupled in series with a shunt capacitor CT1) for transmitting the input signal V_{INP} and a second T-network (which is formed by inductors L21 and L22 coupled in series with a shunt capacitor CT2) for transmitting the input signal V_{INN}, but the present invention is not limited thereto. As long as the matching network can properly transmit the input signals V_{INP} and V_{INN} under an impedance matching condition, implementation of the matching network may vary.

As shown in FIG. 2, the high power path circuit 200H may comprise multiple cascaded rectifier circuits such as J rectifier circuits H1, . . . and HJ, and the low power path circuit 200L may comprise multiple cascaded rectifier circuits such as K rectifier circuits L1, . . . and LK where K may be a positive integer. In addition, the auxiliary path circuit 200A may comprise multiple cascaded rectifier circuits such as the L rectifier circuits A1, . . . and AL. It should be noted that each of the cascaded architecture of the J rectifier circuits H1, . . . and HJ within the high power path circuit 200H and the cascaded architecture of the K rectifier circuits L1, . . . and LK may be similar to that of the J rectifier circuits P1, . . . and PJ illustrated in the embodiment of FIG.1, and will not be described in detail for brevity. In addition, details of the auxiliary path circuit 200A are identical to that of the auxiliary path circuit 100A illustrated in the embodiment of FIG. 1, and are therefore omitted here for brevity.

In some embodiment, the architecture of each rectifier circuit within the high power path circuit 200H, the architecture of each rectifier circuit within the low power path circuit 200L and the architecture of each rectifier circuit within the auxiliary path circuit 200A may be the same, where detailed parameters (e.g. components types with different threshold voltages, component dimensions) of each rectifier circuit within the high power path circuit 200H may be determined (e.g. optimized for power transfer efficiency) for a high RF input power condition (e.g. a condition where the RF input power of the RF input signal V_{IN} is greater than a specific level, which requires better ability of handling larger signal power) according to the output load (e.g. the capacitor C_{L} and the resistor R_{L}) introduced by the energy storage element, detailed parameters (e.g. components types with different threshold voltages, component dimensions) of each rectifier circuit within the low power path circuit 200L may be determined (e.g. optimized for power transfer efficiency) for a low RF input power condition (e.g. a condition where the RF input power of the RF input signal V_{IN} is less than the specific level, which requires better sensitivity) according to the output load (e.g. the capacitor C_{L} and the resistor R_{L}) introduced by the energy storage element, and detailed parameters (e.g. components types with different threshold voltages and/or component dimensions) of each rectifier circuit within the auxiliary path circuit 200A may be determined (e.g. optimized for low power or low voltage operations) according to an output load (e.g. a load introduced by the PMU 210, which is typically much smaller than the capacitor C_{L}) of the auxiliary path circuit 200A. For example, as the high power path circuit 200H is configured to handle the high RF input power condition and the low power path circuit 200L is configured to handle the low RF input power condition, each transistor within the high power path circuit 200H may be a regular-threshold-voltage component (or high-threshold-voltage component), and at least one transistor (e.g. a portion or all of transistors) within the low power path circuit 200L may be a low-threshold-voltage component which has a threshold voltage lower than that of the regular-threshold-voltage component (or the high-threshold-voltage component). In some embodiment, the architecture of each rectifier circuit within the high power path circuit 200H, the architecture of each rectifier circuit within the low power path circuit 200L and the architecture of each rectifier circuit within the auxiliary path circuit 200A may be different from one another, in order to allow each of the high power path circuit 200H, the low power path circuit 200L and the auxiliary path circuit 200A to be implemented by optimized architecture independently.

In comparison with the WPT circuit 100 (which illustrates a single-path power transfer from the antenna 10 to the energy storage element), the WPT circuit 200 (which illustrates a dual-path power transfer from the antenna 10 to the energy storage element) provides a better compromise between a wide dynamic range with improved efficiency and leakage current. The WPT circuit 200 is equipped with two parallel power transfer paths, where the high power path circuit 200H can handle larger input power and can have lower leakage current, and the low power path circuit 200L can achieve better sensitivity and can properly operate under the condition of lower input power.

As mentioned above, the high power path circuit 200H is coupled to the RF front-end circuit 20 and the switch circuit 220H, and the low power path circuit 200L is coupled to the RF front-end circuit 20 and the switch circuit 220L, where the high power path circuit 200H is configured to convert the input signals V_{INP} and V_{INN} into the DC output voltage V_{HOUT}, and the low power path circuit 200L is configured to convert the input signals V_{INP} and V_{INN} into the DC output voltage V_{LOUT}. In this embodiment, the PMU 210 is configured to generate the control signal EN according to the DC output voltage V_{HOUT}. When the DC output voltage V_{HOUT} is pulled up to be greater than a first threshold level such as the threshold level V_{H}, the control signal EN generated by the PMU 210 is switched to a first state (e.g. the voltage level VDD corresponding to the logic value “1”) to make the switch circuit 220H be turned on and make the switch circuit 220L be turned off, in order to conduct the DC output voltage V_{HOUT} to the energy storage element (e.g. the load capacitor C_{L}). When the DC output voltage V_{HOUT}is pulled down to be less than a second threshold level such as the threshold level V_{L}, the control signal EN generated by the PMU 210 is switched to a second state (e.g. the voltage level VSS corresponding to the logic value “0”) to make the switch circuit 220L be turned on and make the switch circuit 220H be turned off, in order to conduct the DC output voltage V_{LOUT}to the energy storage element (e.g. the load capacitor C_{L}).

In this embodiment, the WPT circuit 200 may further comprise an OVP circuit 230, where the OVP circuit 230 is coupled to the output terminal of the high power path circuit 200H, and is configured to limit a voltage level of the DC output voltage V_{HOUT}. In addition, the WPT circuit 200 may further comprise an OVP circuit 240, where the OVP circuit 240 is coupled to the output terminal of the auxiliary path circuit 200A, and is configured to limit the voltage level of the DC supply voltage V_{SUP}. Other details of the OVP circuits 230 and 240 within the WPT circuit 200 shown in FIG. 2 are similar to the OVP circuits 130 and 140 within the WPT circuit 100 shown in FIG. 1, and will be omitted here for brevity.

Similar to the switch circuit 120 shown in FIG. 1, each of the switch circuits 220H and 220L shown in FIG. 2 may be implemented by a transmission gate, where the switch circuit 220H may comprise a N-type transistor N21 and a P-type transistor P21, and the switch circuit 220L may comprise a N-type transistor N22 and a P-type transistor P22. A source terminal of the N-type transistor N21 is coupled to a drain terminal of the P-type transistor P21, and a drain terminal of the N-type transistor N21 is coupled to a source terminal of the P-type transistor P21, where gate terminals of the N-type transistor N21 and the P-type transistor P21 are controlled by the control signal EN and the inverted control signal ENB, respectively. In order to mitigate the body effect, a body terminal of the N-type transistor N21 is coupled to the source terminal of the N-type transistor N21, and a body terminal of the P-type transistor P21 is coupled to the source terminal of the P-type transistor P21. In addition, a source terminal of the N-type transistor N22 is coupled to a drain terminal of the P-type transistor P22, and a drain terminal of the N-type transistor N22 is coupled to a source terminal of the P-type transistor P22, where gate terminals of the N-type transistor N22 and the P-type transistor P22 are controlled by the inverted control signal ENB and the control signal EN, respectively. In order to mitigate the body effect, a body terminal of the N-type transistor N22 is coupled to the source terminal of the N-type transistor N22, and a body terminal of the P-type transistor P22 is coupled to the source terminal of the P-type transistor P22. Thus, when the control signal EN generated by the PMU 210 is switched to the first state (e.g. the voltage level VDD corresponding to the logic value “1”), the inverted control signal ENB may be switched to the second state (e.g. the voltage level VSS corresponding to the logic value “0”), and both the N-type transistor N21 and the P-type transistor P21 may be turned on to conduct the DC output voltage V_{HOUT} to the energy storage element (e.g. the load capacitor C_{L}), where both the N-type transistor N22 and the P-type transistor P22 may be turned off to prevent the DC output voltage V_{LOUT} from being transmitted to the energy storage element (e.g. the load capacitor C_{L}). When the control signal EN generated by the PMU 210 is switched to the second state (e.g. the voltage level VSS corresponding to the logic value “0”), the inverted control signal ENB may be switched to the first state (e.g. the voltage level VDD corresponding to the logic value “1”), and both the N-type transistor N22 and the P-type transistor P22 may be turned on to conduct the DC output voltage V_{LOUT} to the energy storage element (e.g. the load capacitor C_{L}), where both the N-type transistor N21 and the P-type transistor P21 may be turned off to prevent the DC output voltage V_{HOUT} from being transmitted to the energy storage element (e.g. the load capacitor C_{L}).

In this embodiment, the low power path circuit 200L may comprise multiple cascaded rectifier circuits such as the K rectifier circuit L1, . . . and LK. When the DC output voltage V_{HOUT} is pulled up to be greater than the threshold level V_{H}, the output terminal V_{OUT} of each rectifier circuit of the K rectifier circuit L1, . . . and LK may be pulled to a disablement voltage such as the AC ground voltage by K switches S1, . . . and SK (which are respectively coupled to the output terminals V_{OUT} of the K rectifier circuit L1, . . . and LK) in response to the control signal EN being switched to the first state (e.g. the voltage level VDD corresponding to the logic value “1”), in order to disable the low power path circuit 200L.

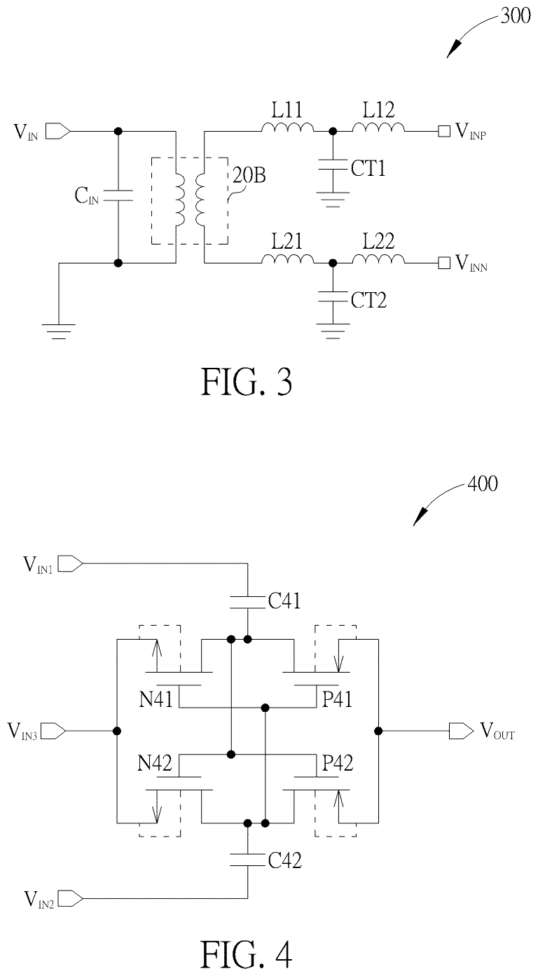

FIG. 4 is a diagram illustrating a first example of a rectifier circuit, such as a rectifier circuit 400, according to an embodiment of the present invention. As mentioned above, each of the main power path circuit 100P and the auxiliary path circuit 100A may comprise multiple cascaded rectifier circuits, and any rectifier circuit (e.g. each rectifier circuit) of the multiple cascaded rectifier circuits may be implemented by the rectifier circuit 400 shown in FIG. 4 with different parameters (e.g. components types with different threshold voltages and/or component dimensions). Similarly, each of the high power path circuit 200H, the low power path circuit 200L and the auxiliary path circuit 200A may comprise multiple cascaded rectifier circuits, and any rectifier circuit (e.g. each rectifier circuit) of the multiple cascaded rectifier circuits may be implemented by the rectifier circuit 400 shown in FIG. 4 with different parameters (e.g. components types with different threshold voltages and/or component dimensions).

As shown in FIG. 4, the rectifier circuit 400 may comprise capacitors C41 and C42, N-type transistors N41 and N42, and P-type transistors P41 and P42. A first end of the capacitor C41 is coupled to the input terminal V_{IN1} and is configured to receive the input signal V_{INP} of the differential input signals {V_{INP}, V_{INN}}, and a first end of the capacitor C42 coupled to the input terminal V_{IN2} and is configured to receive the input signal V_{INN} of the differential input signals {V_{INP}, V_{INN}}. A source terminal of the N-type transistor N41 is coupled to an inter-stage input terminal (e.g. the input terminal V_{IN3}) which is coupled to a previous rectifier circuit, and a drain terminal of the N-type transistor N41 is coupled to a second end of the capacitor C41. A source terminal of the N-type transistor N42 is coupled to the inter-stage input terminal (e.g. the input terminal V_{IN3}), and a drain terminal of the N-type transistor N42 is coupled to a second end of the capacitor C42. A source terminal of the P-type transistor P41 is coupled to an inter-stage output terminal (e.g. the output terminal V_{OUT}) which is coupled to a next rectifier circuit, and a drain terminal of the P-type transistor P41 is coupled to the second end of the capacitor C41. A source terminal of the P-type transistor P42 is coupled to the inter-stage output terminal (e.g. the output terminal V_{OUT}), and a drain terminal of the P-type transistor P42 is coupled to the second end of the capacitor C42. In addition, gate terminals of the N-type transistor N41 and the P-type transistor P41 are coupled to the second end of the capacitor C42, and gate terminals of the N-type transistor N42 and the P-type transistor P42 are coupled to the second end of the capacitor C41.

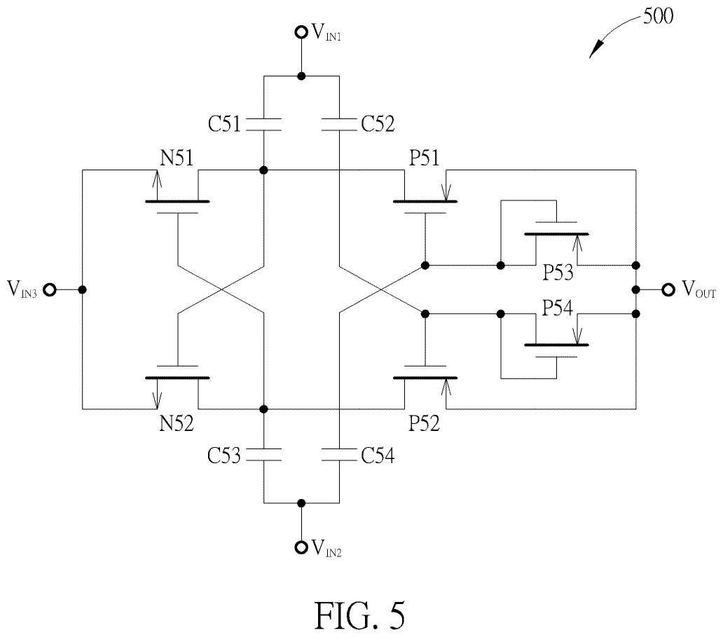

FIG. 5 is a diagram illustrating a second example of a rectifier circuit, such as a rectifier circuit 500, according to an embodiment of the present invention. Note that any rectifier circuit (e.g. each rectifier circuit) of the multiple cascaded rectifier circuits within the main power path circuit 100P, the auxiliary path circuit 100A, the high power path circuit 200H, the low power path circuit 200L and/or the auxiliary path circuit 200A may be implemented by the rectifier circuit 500 according to respective requirements as mentioned above.

As shown in FIG. 5, the rectifier circuit 500 may comprise capacitors C51, C52, C53 and C54, N-type transistors N51 and N52, and P-type transistors P51, P52, P53 and P54. First ends of the capacitors C51 and C52 are coupled to the input terminal V_{IN1} and are configured to receive the input signal V_{INP} of the differential input signals {V_{INP}, V_{INN}}, and first ends of the capacitors C53 and C54 are coupled to the input terminal V_{IN2} and are configured to receive the input signal V_{INN} of the differential input signals {V_{INP}, V_{INN}}. A source terminal of the N-type transistor N51 is coupled to an inter-stage input terminal (e.g. the input terminal V_{IN3}) which is coupled to a previous rectifier circuit, a drain terminal of the N-type transistor N51 is coupled to a second end of the capacitor C51, and a gate terminal of the N-type transistor N51 is coupled to a second end of the capacitor C53. A source terminal of the N-type transistor N52 is coupled to the inter-stage input terminal (e.g. the input terminal V_{IN3}), a drain terminal of the N-type transistor N52 is coupled to the second end of the capacitor C53, and a gate terminal of the N-type transistor N52 is coupled to the second end of the capacitor C51. A source terminal of the P-type transistor P51 is coupled to an inter-stage output terminal (e.g. the output terminal V_{OUT}) which is coupled to a next rectifier circuit, a drain terminal of the P-type transistor P51 is coupled to the second end of the capacitor C51, and a gate terminal of the P-type transistor P51 is coupled to a second end of the capacitor C54. A source terminal of the P-type transistor P52 is coupled to the inter-stage output terminal (e.g. the output terminal V_{OUT}), a drain terminal of the P-type transistor P52 is coupled to the second end of the capacitor C53, and a gate terminal of the P-type transistor P52 is coupled to a second end of the capacitor C52. A source terminal of the P-type transistor P53 is coupled to the inter-stage output terminal (e.g. the output terminal V_{OUT}), a drain terminal of the P-type transistor P53 is coupled to the second end of the capacitor C54, and a gate terminal of the P-type transistor P53 is coupled to the drain terminal of the P-type transistor P53. A source terminal of the P-type transistor P54 is coupled to the inter-stage output terminal (e.g. the output terminal V_{OUT}), a drain terminal of the P-type transistor P54 is coupled to the second end of the capacitor C52, and a gate terminal of the P-type transistor P54 is coupled to the drain terminal of the P-type transistor P54. In this embodiment, all transistors within the rectifier circuit 500 may be implemented by regular-threshold-voltage components (e.g. regular-threshold-voltage transistors), which inherently limit leakage current.

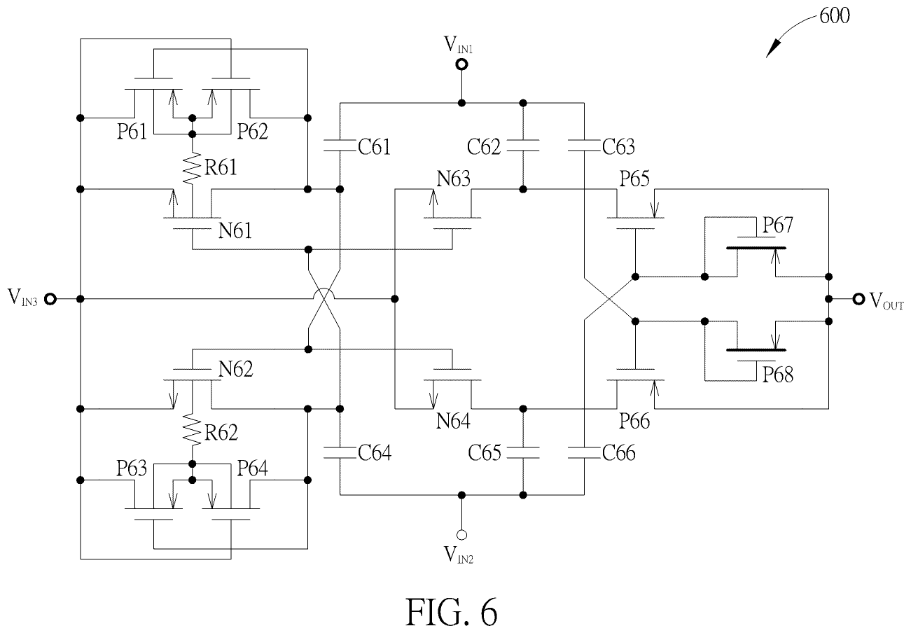

FIG. 6 is a diagram illustrating a third example of a rectifier circuit, such as a rectifier circuit 600, according to an embodiment of the present invention. Note that any rectifier circuit (e.g. each rectifier circuit) of the multiple cascaded rectifier circuits within the main power path circuit 100P, the auxiliary path circuit 100A, the high power path circuit 200H, the low power path circuit 200L and/or the auxiliary path circuit 200A may be implemented by the rectifier circuit 600 according to respective requirements as mentioned above.

As shown in FIG. 6, the rectifier circuit 600 may comprise resistors R61 and R62, capacitors C61, C62, C63, C64, C65 and C66, P-type transistors P61, P62, P63, P64, P65, P66, P67 and P68, and N-type transistors N61, N62, N63 and N64. First ends of the capacitors C61, C62 and C63 are coupled to the input terminal V_{IN1} and are configured to receive the input signal V_{INP} of the differential input signals {V_{INP}, V_{INN}}, and first ends of the capacitors C64, C65 and C66 are coupled to input terminal V_{IN2} and are configured to receive the input signal V_{INN} of the differential input signals {V_{INP}, V_{INN}}. A source terminal of the P-type transistor P61 is coupled to a first end of the resistor R61, a drain terminal of the P-type transistor P61 is coupled to an inter-stage input terminal (e.g. the input terminal V_{IN3}) which is coupled to a previous rectifier circuit, and a gate terminal of the P-type transistor P61 is coupled to a second end of the capacitor C61, where a body terminal of the P-type transistor P61 is coupled to the first end of the resistor R61. A source terminal of the P-type transistor P62 is coupled to the first end of the resistor R61, a drain terminal of the P-type transistor P62 is coupled to the second end of the capacitor C61, and a gate terminal of the P-type transistor P62 is coupled to the inter-stage input terminal (e.g. the input terminal V_{IN3}), where a body terminal of the P-type transistor P62 is coupled to the first end of the resistor R61. A source terminal of the P-type transistor P63 is coupled to a first end of the resistor R62, a drain terminal of the P-type transistor P63 is coupled to the inter-stage input terminal (e.g. the input terminal V_{IN3}), and a gate terminal of the P-type transistor P63 is coupled to a second end of the capacitor C64, where a body terminal of the P-type transistor P63 is coupled to the first end of the resistor R62. A source terminal of the P-type transistor P64 is coupled to the first end of the resistor R62, a drain terminal of the P-type transistor P64 is coupled to the second end of the capacitor C64, and a gate terminal of the P-type transistor P64 is coupled to the inter-stage input terminal (e.g. the input terminal V_{IN3}), where a body terminal of the P-type transistor P64 is coupled to the first end of the resistor R62. A source terminal of the N-type transistor N61 is coupled to the inter-stage input terminal (e.g. the input terminal V_{IN3}), a drain terminal of the N-type transistor N61 is coupled to the second end of the capacitor C61, a gate terminal of the N-type transistor N61 is coupled to the second end of the capacitor C64, and a body terminal of the N-type transistor N61 is coupled to a second end of the resistor R61. A source terminal of the N-type transistor N62 is coupled to the inter-stage input terminal (e.g. the input terminal V_{IN3}), a drain terminal of the N-type transistor N62 is coupled to the second end of the capacitor C64, a gate terminal of the N-type transistor N62 is coupled to the second end of the capacitor C61, and a body terminal of the N-type transistor N62 is coupled to a second end of the resistor R62. A source terminal of the N-type transistor N63 is coupled to the inter-stage input terminal (e.g. the input terminal V_{IN3}), a drain terminal of the N-type transistor N63 is coupled to a second end of the capacitor C62, and a gate terminal of the N-type transistor N63 is coupled to a second end of the capacitor C64. A source terminal of the N-type transistor N64 is coupled to the inter-stage input terminal (e.g. the input terminal V_{IN3}), a drain terminal of the N-type transistor N64 is coupled to a second end of the capacitor C65, and a gate terminal of the N-type transistor N64 is coupled to a second end of the capacitor C61. A source terminal of the P-type transistor P65 is coupled to an inter-stage output terminal (e.g. the output terminal V_{OUT}) which is coupled to a next rectifier circuit, a drain terminal of the P-type transistor P65 is coupled to the second end of the capacitor C62, and a gate terminal of the P-type transistor P65 is coupled to a second end of the capacitor C66. A source terminal of the P-type transistor P66 is coupled to the inter-stage output terminal (e.g. the output terminal V_{OUT}), a drain terminal of the P-type transistor P66 is coupled to the second end of the capacitor C65, and a gate terminal of the P-type transistor P66 is coupled to a second end of the capacitor C63. A source terminal of the P-type transistor P67 is coupled to the inter-stage output terminal (e.g. the output terminal V_{OUT}), a drain terminal of the P-type transistor P67 is coupled to the second end of the capacitor C66, and a gate terminal of the P-type transistor P67 is coupled to the drain terminal of the P-type transistor P67. A source terminal of the P-type transistor P68 is coupled to the inter-stage output terminal (e.g. the output terminal V_{OUT}), a drain terminal of the P-type transistor P68 is coupled to the second end of the capacitor C63, and a gate terminal of the P-type transistor P68 is coupled to the drain terminal of the P-type transistor P68.

The rectifier circuit 600 is implemented based on various considerations, such as detection of low input power for better sensitivity. Thus, the N-type transistors N61, N62, N63 and N64 and the P-type transistors P61, P62, P63, P64, P65 and P66 may be implemented by low-threshold-voltage components (e.g. low-threshold-voltage transistors or ultra-low voltage threshold (ULVT) transistors) to improve sensitivity of the WPT system (e.g. the WPT circuit 100 or 200), to enable the rectifier circuit 600 to function under conditions of lower input powers, and body bias is adopted on the N-type transistors N61 and N62 and the P-type transistor P61, P62, P63 and P64. In addition, the P-type transistor P67 and P68 may be implemented by regular-threshold-voltage components (e.g. regular-threshold-voltage transistor which is fabricated with thick-oxide structure), in order to ensure robust performance and reduced reverse leakage under a cross-coupled structure of the rectifier circuit 600. In detail, the ULVT transistors may introduce larger leakage currents (e.g. reverse leakage currents) which results in discharge of the storage element when the RF input power is below the sensitivity of the rectifier circuit 600. To reduce the reverse leakage currents, the P-type transistor P67 (which is diode connected) provides a large resistance on a path from the output terminal V_{OUT} to the input terminal V_{IN2}, and the P-type transistor P68 (which is diode connected) provides a large resistance on a path from the output terminal V_{OUT} to the input terminal V_{IN1}, where the P-type transistor P67 (which is a regular-threshold-voltage transistor) will not result in a high voltage across the P-type transistor P65 (e.g. a voltage difference between the gate terminal and the source terminal of the P-type transistor P65), and the P-type transistor P68 (which is a regular-threshold-voltage transistor) will not result in a high voltage across the P-type transistor P66 (e.g. a voltage difference between the gate terminal and the source terminal of the P-type transistor P66). Thus, the P-type transistors P65 and P66 can properly work without being damaged by voltages introduced by resistances of the P-type transistors P67 and P68.

Operations of the rectifier circuit 600 may be described under two conditions, such as a condition of a positive half cycle of the RF input signal V_{IN} (e.g. V_{INP}>V_{INN}) and a condition of a negative half cycle of the RF input signal V_{IN} (e.g. V_{INP}<V_{INN}). When the RF input signal V_{IN} is in the positive half cycle, the P-type transistors P65 and P67 may conduct the input signal V_{INP} from the input terminal V_{IN1} to the output terminal V_{OUT}, and simultaneously the N-type transistors N62 and N64 may conduct a return signal (e.g. a signal from a previous rectifier circuit) from the input terminal V_{IN3} to the input terminal V_{INN}. In addition, to enable small signals to be detected, the P-type transistors P63 and P64 and the resistor R62 perform threshold voltage compensation to reduce a threshold voltage of the N-type transistor N62. Furthermore, to reduce a reverse leakage current from the input terminal V_{IN1} to the input terminal V_{IN3}, the P-type transistors P61 and P62 and the resistor R61 perform threshold voltage compensation to increase a threshold voltage of the N-type transistor N61, thereby restricting the reverse leakage current. When the RF input signal V_{IN} is in the negative half cycle, the P-type transistors P66 and P68 may conduct the input signal V_{INN} from the input terminal V_{IN2} to the output terminal V_{OUT}, and simultaneously the N-type transistors N61 and N63 may conduct the return signal (e.g. the signal from the previous rectifier circuit) from the input terminal V_{IN3}to the input terminal V_{INP}. In addition, to enable small signals to be detected, the P-type transistors P61 and P62 and the resistor R61 perform threshold voltage compensation to reduce a threshold voltage of the N-type transistor N61. Furthermore, to reduce a reverse leakage current from the input terminal V_{IN2} to the input terminal V_{IN3}, the P-type transistors P63 and P64 and the resistor R62 perform threshold voltage compensation to increase a threshold voltage of the N-type transistor N62, thereby restricting the reverse leakage current.

For a dual-path architecture such as the WPT circuit 200 shown in FIG. 2, each of the rectifier circuits H1, . . . and HJ within the high power path circuit 200H is preferred to be implemented by the rectifier circuit 500 shown in FIG. 5, and each of the rectifier circuits L1, . . . and LK within the low power path circuit 200L is preferred to be implemented by the rectifier circuit 600 shown in FIG. 6, but the present invention is not limited thereto.

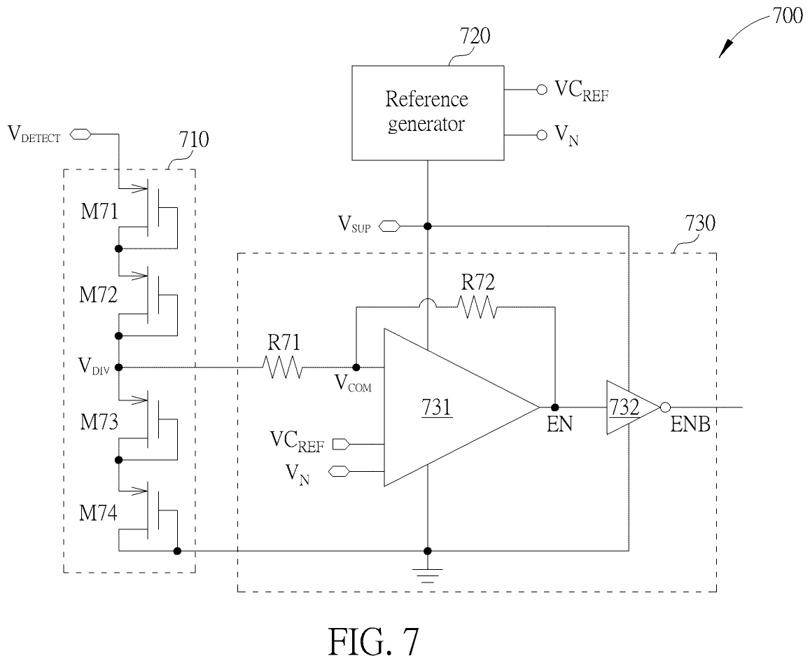

FIG. 7 is a diagram illustrating a control circuit such as a PMU 700 according to an embodiment of the present invention, where the PMU 700 may be an example of the PMU 110 shown in FIG. 1 or the PMU 210 shown in FIG. 2. As shown in FIG. 7, the PMU 700 may comprise a voltage divide 710, a reference generator 720 and a hysteresis comparator 730, where the hysteresis comparator 730 is coupled to the voltage divider 710 and the reference generator 720. In this embodiment, the voltage divider 710 is configured to receive a DC detected voltage VDETECT (which may be an example of the DC output voltage V_{ROUT} shown in FIG. 1 or the DC output voltage V_{HOUT} shown in FIG. 2) and reduce a level of the detected voltage V_{DETECT} to generate a divided output voltage V_{DIV}. The reference generator 720 is configured to utilize the DC supply voltage V_{SUP} as a power source and generate a comparator reference voltage VC_{REF} and a bias voltage V_{N}. The hysteresis comparator 730 is configured to utilize the DC supply voltage V_{SUP} as a power source and determine whether the detected voltage V_{DETECT} is increased to be greater than a first threshold level (e.g. the threshold level V_{H}) or whether the detected voltage V_{DETECT} is decreased to be lower than a second threshold level (e.g. the threshold level V_{L}) according to the divided output voltage V_{DIV}, the comparator reference voltage VC_{REF} and the bias voltage V_{N}, in order to generate the control signal EN and the inverted control signal ENB, where the hysteresis comparator 730 may utilize the DC supply voltage V_{SUP} as a power source.

In this embodiment, the voltage divider 710 may comprise multiple diode-connected transistors such as M71, M72, M73 and M74, where the diode-connected transistors are coupled in series between a terminal receiving the detected voltage V_{DETECT} and a terminal receiving a reference voltage such as the AC ground voltage. A first portion of the multiple diode-connected transistors, such as the diode-connected transistors M71 and M72, are coupled between the terminal receiving the detected voltage V_{DETECT} and a terminal generating the divided output voltage V_{DIV}, and a second portion of the multiple diode-connected transistors, such as the diode-connected transistors M73 and M74, are coupled between the terminal generating the divided output voltage V_{DIV} and the terminal receiving the AC ground voltage.

In addition, the hysteresis comparator 730 may comprise resistors R71 and R72, an internal amplifier 731 and an inverter 732, where a first end of the resistor R71 is configured to receive the divided output voltage V_{DIV}, a first end of the resistor R72 is coupled to a second end of the resistor R71, a first input terminal of the internal amplifier 731 is coupled to the second end of the resistor R71, a second input terminal of the internal amplifier 731 is configured to receive the comparator reference voltage VC_{REF}, a bias control terminal of the internal amplifier 731 is configured to receive the bias voltage V_{N}, an output terminal of the internal amplifier 731 is coupled to a second end of the resistor R72 and an input terminal of the inverter 732. Note that both the internal amplifier 731 and the inverter 732 utilize the DC supply voltage V_{SUP}as a power source. In detail, a comparator input voltage Vcom is generated on the first input terminal of the internal amplifier 731 according to the divided output voltage V_{DIV}, the resistors R71 and R72 and a present state of the control signal EN (which is output from the output terminal of the internal amplifier 731), where the internal amplifier 731 is configured to control states (e.g. a next state) of the control signal EN according to whether the comparator input voltage Vcom is greater than the comparator reference voltage VC_{REF}, and the inverter 732 may generate the inverted control signal ENB according to the control signal EN.

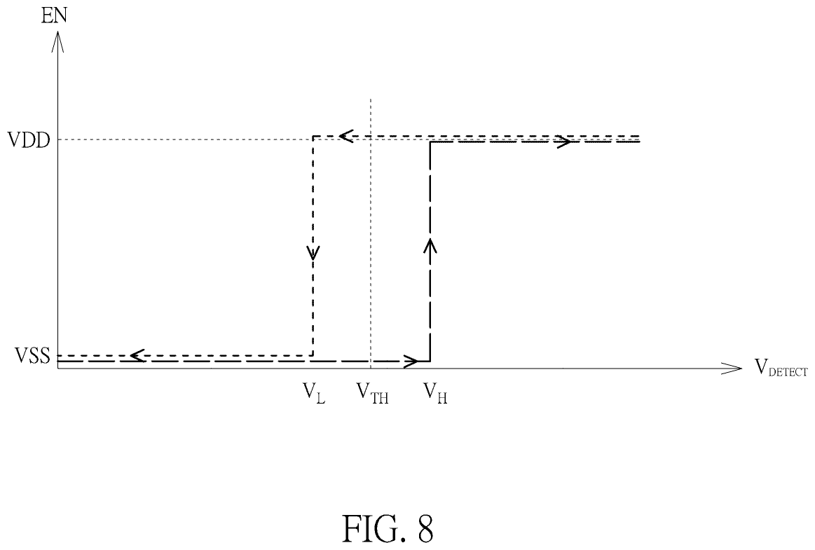

FIG. 8 is a diagram illustrating operations of the hysteresis comparator 730 according to an embodiment of the present invention, and more particularly, a condition where the detected voltage V_{DETECT} is increasing and a condition of the detected voltage V_{DETECT} is decreasing are shown in FIG. 8. Assume that V_{DIV}=K_{R}×V_{DETECT}, where KR may represent a dividing ratio which is determined according to the diode connected-transistors M71, M72, M73 and M64, and more particularly, is determined by a number of diode-connected transistors coupled between the terminal receiving the detected voltage V_{DETECT} and the terminal generating the divided output voltage V_{DIV} (e.g. a number of the diode-connected transistors M71 and M72) and a number of diode-connected transistors coupled between the terminal generating the divided output voltage V_{DIV} and the terminal receiving the AC ground voltage (e.g. a number of the diode-connected transistors M73 and M74).

Under the condition where the detected voltage V_{DETECT} is increasing, when the detected voltage V_{DETECT} (e.g. the DC output voltage V_{ROUT} or the DC output voltage V_{HOUT}) is pulled up to be greater than the threshold level V_{H} (e.g. thereby making the comparator input voltage V_{COM} become greater than the comparator reference voltage VC_{REF}), the control signal EN generated by the hysteresis comparator 730 may be switched to a first state (e.g. the voltage level VDD corresponding to the logic value “1”) from a second state (e.g. the voltage level VSS corresponding to the logic value “0”), where VC_{REF}=V_{H}×K_{R}×(R72/(R71+R72)). Under the condition where the detected voltage V_{DETECT} is decreasing, when the detected voltage V_{DETECT} (e.g. the DC output voltage V_{ROUT} or the DC output voltage V_{HOUT}) is pulled down to be less than the threshold level V_{L}(e.g. thereby making the comparator input voltage V_{COM} become less than the comparator reference voltage VC_{REF}), the control signal EN generated by the hysteresis comparator 730 may be switched to the second state (e.g. the voltage level VSS corresponding to the logic value “0”) from the first state (e.g. the voltage level VDD corresponding to the logic value “1”), where VC_{REF}=(VDD−V_{DIV})×(R1/(R1+R2))+V_{DIV}. Assume that a threshold level V_{TH} shown in FIG. 8 may represent a transition point of a typical comparator without hysteresis, where the threshold level V_{H} may be greater than the threshold level V_{TH}, and the threshold level V_{L} may be less than the threshold level V_{TH}, which means the threshold level V_{H} is greater than the threshold level V_{L}. Based on the above operations, the hysteresis comparator 730 can be less sensitive to ripples on the detected voltage V_{DETECT} (e.g. the DC output voltage V_{ROUT} or the DC output voltage V_{HOUT}), thereby preventing the ripples on the detected voltage V_{DETECT} from resulting switching noise.

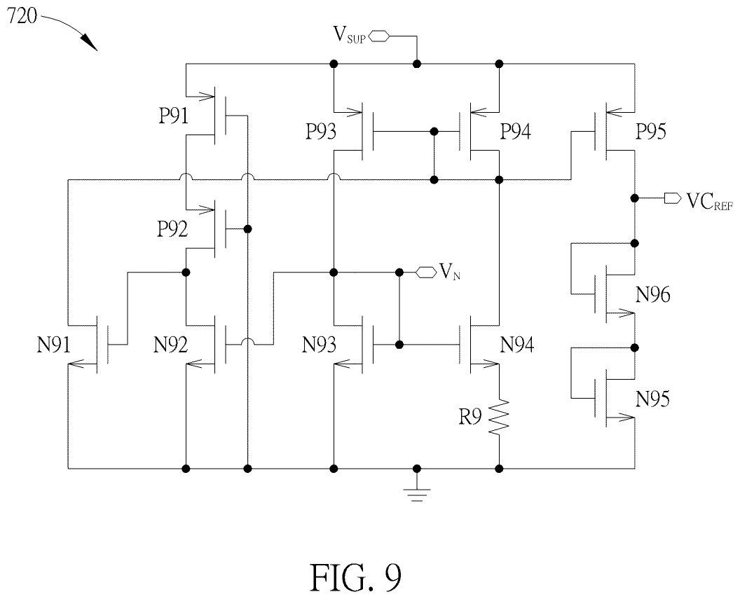

FIG. 9 is a diagram illustrating details of the reference generator 720 shown in FIG. 7 according to an embodiment of the present invention, where the reference generator 720 may be implemented by a constant-transconductance architecture. As shown in FIG. 9, the reference generator 720 may comprise a resistor R9, N-type transistors N91, N92, N93, N94, N95 and N96, and P-type transistors P91, P92, P93, P94 and P95. A source terminal of the N-type transistor N91 is coupled to a reference voltage such as the AC ground voltage, and a drain terminal of the N-type transistor N91 is coupled to gate terminals of the P-type transistors P93, P94 and P95. A source terminal of the N-type transistor N92 is coupled to the AC ground voltage, and a drain terminal of the N-type transistor N92 is coupled to a gate terminal of the N-type transistor N91 and a drain terminal of the P-type transistor P92. A source terminal of the P-type transistor P92 is coupled to a drain terminal of the P-type transistor P91, and a source terminal of the P-type transistor P91 is coupled to the DC supply voltage V_{SUP}, where gate terminals of the P-type transistors P91 and P92 are couple to the AC ground voltage. A source terminal of the N-type transistor N93 is coupled to the AC ground voltage, a drain terminal of the N-type transistor N93 is coupled to gate terminals of the N-type transistors N93, N92 and N94 and a drain terminal of the P-type transistor P93, and a source terminal of the P-type transistor P93 is coupled to the DC supply voltage V_{SUP}, where the drain terminal of the P-type transistor P93 is configured to output the bias voltage V_{N}. A first end of the resistor R9 is coupled to the AC ground voltage, a second end of the resistor R9 is coupled to a source terminal of the N-type transistor N94, a drain terminal of the N-type transistor N94 is coupled to a drain terminal of the P-type transistor P94, and a source terminal of the P-type transistor P94 is coupled to the DC supply voltage V_{SUP}. A source terminal of the N-type transistor N95 is coupled to the AC ground voltage, a drain terminal of the N-type transistor N95 is coupled to a gate terminal of the N-type transistor N95 and a source terminal of the N-type transistor N96, a drain terminal of the N-type transistor N96 is coupled to a gate terminal of the N-type transistor N96 and a drain terminal of a P-type transistor P95, and a source terminal of the P-type transistor P95 is coupled to the DC supply voltage Vsur, where the drain terminal of the P-type transistor P95 is configured to output the comparator reference voltage VC_{REF}.

The reference generator 720 may have a start-up circuit (e.g. the N-type transistors N91 and N92 and the P-type transistors P91 and P92), which utilizes a P-type-transistor-based resistor (e.g. the P-type transistors P91 and P92) to increase an equivalent resistance, thereby minimizing power consumption. In addition, the reference generator 720 utilize the N-type transistor N94 and the resistor R9 for temperature compensation, thereby making the comparator reference voltage VC_{REF} and the bias voltage V_{N} be less sensitive to process, voltage and temperature variation. A path that output the comparator reference voltage VC_{REF} path utilizes a N-type-transistor-based resistor (e.g. which is formed by the N-type transistors N95 and N96) to increase an equivalent resistance and to minimize the power consumption. For example, change to the comparator reference voltage VC_{REF} and the bias voltage V_{N} can be much less than change to the DC supply voltage V_{SUP}.

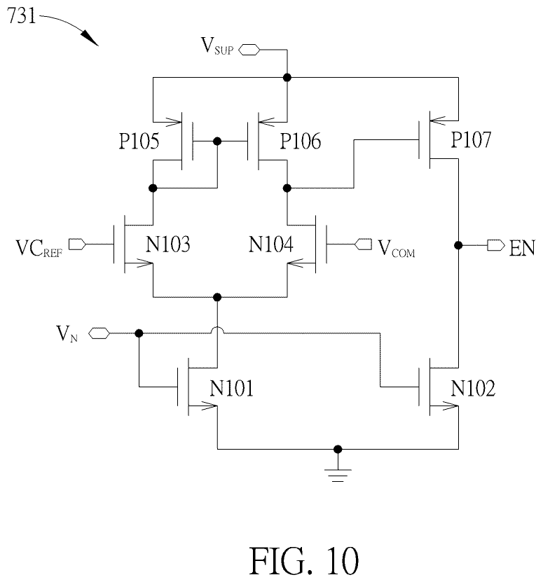

FIG. 10 is a diagram illustrating details of the internal amplifier 731 shown in FIG. 7 according to an embodiment of the present invention. As shown in FIG. 10, the internal amplifier 731 may comprise N-type transistors N101, N102, N103 and N104 and P-type transistors P105, P106 and P107. Source terminals of the N-type transistors N101 and N102 are coupled to a reference voltage such as the AC ground voltage, and gate terminals of the N-type transistor N101 and N102 are configured to receive the bias voltage V_{N}. Source terminals of the N-type transistors N103 and N104 are coupled to a drain terminal of the N-type transistor N101, where gate terminals of the N-type transistors N103 and N104 are configured to receive the comparator reference voltage VC_{REF} and the comparator input voltage V_{COM}. A drain terminal of the P-type transistor P105 is coupled to a drain terminal of the N-type transistor N103, and a drain terminal of the P-type transistor P106 is coupled to a drain terminal of the N-type transistor N104, where source terminals of the P-type transistors P105 and P106 are coupled to the DC output voltage V_{SUP}, and gate terminals of the P-type transistors P105 and P106 are coupled to the drain terminal of the N-type transistor N103. A gate terminal of the P-type transistor P107 is coupled to the drain terminal of the P-type transistor P106, a source terminal of the P-type transistor P107 is coupled to the DC supply voltage V_{SUP}, and a drain terminal of the P-type transistor P107 is coupled to a drain terminal of the N-type transistor N102, where the drain terminals of the N-type transistor N102 and the P-type transistor P107 are configured to output the control signal EN.

To summarize, the embodiment of the present invention further utilize an auxiliary path circuit (e.g. the auxiliary path circuit 100A shown in FIG. 1 or the auxiliary path circuit 200A shown in FIG. 2) dedicated to power up supporting circuits such as the PMU 110 shown in FIG. 1 or the PMU 210 shown in FIG. 2. As the auxiliary path circuit is an independent path, which can be separately optimized to improve an overall performance better over a wide input power range, where an output voltage (e.g. the DC supply voltage V_{SUP}) of the auxiliary path circuit can be limited to be lower than that of main power path circuit(s) (e.g. the main power path circuit 100P shown in FIG. 1 or the high power path circuit 200H and the low power path circuit 200L shown in FIG. 2), thereby greatly reduce power consumption of the support circuits.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless power transfer (WPT) circuit, comprising:
a radio frequency (RF) front-end circuit, configured to convert a single-end input signal received by an antenna into differential input signals;
at least one power path circuit, coupled to the RF front-end circuit, configured to convert the differential input signals respectively received by a first input terminal and a second input terminal of the at least one power path circuit into a direct current (DC) output voltage;
an auxiliary path circuit, coupled to the RF front-end circuit, configured to convert the differential input signals respectively received by a first input terminal and a second input terminal of the auxiliary path circuit into a DC supply voltage;
a control circuit, coupled to the auxiliary path circuit, configured to utilize the DC supply voltage as a power source and generate a control signal according to the DC output voltage; and
a switch circuit, coupled between an output terminal of the at least one power path circuit and an energy storage element, configured to determine whether to conduct the DC output voltage to the energy storage element according to the control signal.

2. The WPT circuit of claim 1, wherein the RF front-end circuit comprises:
a balanced-to-unbalanced (balun) transformer, configured to convert the single-end input signal into the differential input signals; and
a matching network, coupled between the balun transformer and the at least one power path circuit, configured to transmit the differential input signals to the at least one power path circuit.

3. The WPT circuit of claim 1, further comprising:
a RF limiter, coupled between the first input terminal and the second input terminal of the at least one power path circuit, configured to limit a voltage difference between the differential input signals.

4. The WPT circuit of claim 3, wherein the RF limiter comprises:
at least one first diode-connected transistor, wherein a gate terminal and a drain terminal of the at least one first diode-connected transistor is coupled to the first input terminal of the at least one power path circuit; and
at least one second diode-connected transistor, wherein a gate terminal and a drain terminal of the at least one second diode-connected transistor is coupled to the second input terminal of the at least one power path circuit.

5. The WPT circuit of claim 1, further comprising:
an over-voltage protection (OVP) circuit, coupled to the output terminal of the at least one power path circuit, configured to limit a voltage level of the DC output voltage.

6. The WPT circuit of claim 5, wherein the OVP circuit comprise M stacked diodes, M is a positive integer, a cut-in voltage of each of the M stacked diodes is VCUTIN, and the voltage level of the DC output voltage is limited below (M×V_{CUTIN}).

7. The WPT circuit of claim 1, further comprising:
an over-voltage protection (OVP) circuit, coupled to an output terminal of the auxiliary path circuit, configured to limit a voltage level of the DC supply voltage.

8. The WPT circuit of claim 7, wherein the OVP circuit comprise N stacked diodes, N is a positive integer, a cut-in voltage of each of the N stacked diodes is VCUTIN, and the voltage level of the DC supply voltage is limited below (N×V_{CUTIN}).

9. The WPT circuit of claim 1, wherein the switch circuit comprises a N-type transistor and a P-type transistor, a source terminal of the N-type transistor is coupled to a drain terminal of the P-type transistor, a drain terminal of the N-type transistor is coupled to a source terminal of the P-type transistor, and gate terminals of the N-type transistor and the P-type transistor are controlled by the control signal and an inverted control signal of the control signal, respectively.

10. The WPT circuit of claim 1, wherein each of the at least one power path circuit and the auxiliary path circuit comprise multiple cascaded rectifier circuits, and a rectifier circuit of the multiple cascaded rectifier circuits comprises:
a first capacitor, wherein a first end of the first capacitor is configured to receive a first input signal of the differential input signals;
a second capacitor, wherein a first end of the second capacitor is configured to receive a second input signal of the differential input signals;
a first N-type transistor, wherein a source terminal of the first N-type transistor is coupled to an inter-stage input terminal which is coupled to a previous rectifier circuit, and a drain terminal of the first N-type transistor is coupled to a second end of the first capacitor;
a second N-type transistor, wherein a source terminal of the second N-type transistor is coupled to the inter-stage input terminal, and a drain terminal of the second N-type transistor is coupled to a second end of the second capacitor;
a first P-type transistor, wherein a source terminal of the first P-type transistor is coupled to an inter-stage output terminal which is coupled to a next rectifier circuit, and a drain terminal of the first P-type transistor is coupled to the second end of the first capacitor; and
a second P-type transistor, wherein a source terminal of the second P-type transistor is coupled to the inter-stage output terminal, and a drain terminal of the second P-type transistor is coupled to the second end of the second capacitor;
wherein gate terminals of the first N-type transistor and the first P-type transistor are coupled to the second end of the second capacitor, and gate terminals of the second N-type transistor and the second P-type transistor are coupled to the second end of the first capacitor.

11. The WPT circuit of claim 1, wherein the at least one power path circuit comprises:
a main power path circuit, coupled to the RF front-end circuit and the switch circuit, configured to convert the differential input signals into the DC output voltage;
wherein:
when the DC output voltage is pulled up to be greater than a first threshold level, the control signal generated by the control circuit is switched to a first state to make the switch circuit be turned on, in order to conduct the DC output voltage to the energy storage element; and
when the DC output voltage is pulled down to be less than a second threshold level, the control signal generated by the control circuit is switched to a second state to make the switch circuit be turned off, in order to prevent the DC output voltage from being transmitted to the energy storage element.

12. The WPT circuit of claim 1, wherein the at least one power path circuit comprises:
a first power path circuit, coupled to the RF front-end circuit and a first switch circuit of the switch circuit, configured to convert the differential input signals into a first DC output voltage of the DC output voltage; and
a second power path circuit, coupled to the RF front-end circuit and a second switch circuit of the switch circuit, configured to convert the differential input signals into a second DC output voltage of the DC output voltage;
wherein:
the control circuit is configured to generate the control signal according to the first DC output voltage;
when the first DC output voltage is pulled up to be greater than a first threshold level, the control signal generated by the control circuit is switched to a first state to make the first switch circuit be turned on and make the second switch circuit be turned off, in order to conduct the first DC output voltage to the energy storage element; and
when the first DC output voltage is pulled down to be less than a second threshold level, the control signal generated by the control circuit is switched to a second state to make the second switch circuit be turned on and make the first switch circuit be turned off, in order to conduct the second DC output voltage to the energy storage element.

13. The WPT circuit of claim 12, wherein each transistor within the first power path circuit is a regular-threshold-voltage component, and at least one transistor within the second power path circuit is a low-threshold-voltage component, wherein a threshold voltage of the low-threshold-voltage component is lower than a threshold voltage of the regular-threshold-voltage component.

14. The WPT circuit of claim 12, wherein the second power path circuit comprises multiple cascaded rectifier circuits, and when the first DC output voltage is pulled up to be greater than the first threshold level, an output terminal of each rectifier circuit of the multiple cascaded rectifier circuits is pulled to a disablement voltage in response to the control signal being switched to the first state, in order to disable the second power path circuit.

15. The WPT circuit of claim 12, wherein the first power path circuit comprises multiple cascaded rectifier circuits, and a rectifier circuit of the multiple cascaded rectifier circuits comprises:
a first capacitor, wherein a first end of the first capacitor is configured to receive a first input signal of the differential input signals;
a second capacitor, wherein a first end of the second capacitor is configured to receive the first input signal;
a third capacitor, wherein a first end of the third capacitor is configured to receive a second input signal of the differential input signals;
a fourth capacitor, wherein a first end of the fourth capacitor is configured to receive the second input signal;
a first N-type transistor, wherein a source terminal of the first N-type transistor is coupled to an inter-stage input terminal which is coupled to a previous rectifier circuit, a drain terminal of the first N-type transistor is coupled to a second end of the first capacitor, and a gate terminal of the first N-type transistor is coupled to a second end of the third capacitor;
a second N-type transistor, wherein a source terminal of the second N-type transistor is coupled to the inter-stage input terminal, a drain terminal of the second N-type transistor is coupled to the second end of the third capacitor, and a gate terminal of the second N-type transistor is coupled to the second end of the first capacitor;
a first P-type transistor, wherein a source terminal of the first P-type transistor is coupled to an inter-stage output terminal which is coupled to a next rectifier circuit, a drain terminal of the first P-type transistor is coupled to the second end of the first capacitor, and a gate terminal of the first P-type transistor is coupled to a second end of the fourth capacitor;
a second P-type transistor, wherein a source terminal of the second P-type transistor is coupled to the inter-stage output terminal, a drain terminal of the second P-type transistor is coupled to the second end of the third capacitor, and a gate terminal of the second P-type transistor is coupled to a second end of the second capacitor;
a third P-type transistor, wherein a source terminal of the third P-type transistor is coupled to the inter-stage output terminal, a drain terminal of the third P-type transistor is coupled to the second end of the fourth capacitor, and a gate terminal of the third P-type transistor is coupled to the drain terminal of the third P-type transistor; and
a fourth P-type transistor, wherein a source terminal of the fourth P-type transistor is coupled to the inter-stage output terminal, a drain terminal of the fourth P-type transistor is coupled to the second end of the second capacitor, and a gate terminal of the fourth P-type transistor is coupled to the drain terminal of the fourth P-type transistor.

16. The WPT circuit of claim 12, wherein the second power path circuit comprises multiple cascaded rectifier circuits, and a rectifier circuit of the multiple cascaded rectifier circuits comprises:
a first resistor;
a second resistor;
a first capacitor, wherein a first end of the first capacitor is configured to receive a first input signal of the differential input signals;
a second capacitor, wherein a first end of the second capacitor is configured to receive the first input signal;
a third capacitor, wherein a first end of the third capacitor is configured to receive the first input signal;
a fourth capacitor, wherein a first end of the fourth capacitor is configured to receive a second input signal of the differential input signals;
a fifth capacitor, wherein a first end of the fifth capacitor is configured to receive the second input signal;
a sixth capacitor, wherein a first end of the sixth capacitor is configured to receive the second input signal;
a first P-type transistor, wherein a source terminal of the first P-type transistor is coupled to a first end of the first resistor, a drain terminal of the first P-type transistor is coupled to an inter-stage input terminal which is coupled to a previous rectifier circuit, and a gate terminal of the first P-type transistor is coupled to a second end of the first capacitor;
a second P-type transistor, wherein a source terminal of the second P-type transistor is coupled to the first end of the first resistor, a drain terminal of the second P-type transistor is coupled to the second end of the first capacitor, and a gate terminal of the second P-type transistor is coupled to the inter-stage input terminal;
a third P-type transistor, wherein a source terminal of the third P-type transistor is coupled to a first end of the second resistor, a drain terminal of the third P-type transistor is coupled to the inter-stage input terminal, and a gate terminal of the third P-type transistor is coupled to a second end of the fourth capacitor;
a fourth P-type transistor, wherein a source terminal of the fourth P-type transistor is coupled to the first end of the second resistor, a drain terminal of the fourth P-type transistor is coupled to the second end of the fourth capacitor, and a gate terminal of the fourth P-type transistor is coupled to the inter-stage input terminal;
a first N-type transistor, wherein a source terminal of the first N-type transistor is coupled to the inter-stage input terminal, a drain terminal of the first N-type transistor is coupled to the second end of the first capacitor, a gate terminal of the first N-type transistor is coupled to the second end of the fourth capacitor, and a body terminal of the first N-type transistor is coupled to a second end of the first resistor;
a second N-type transistor, wherein a source terminal of the second N-type transistor is coupled to the inter-stage input terminal, a drain terminal of the second N-type transistor is coupled to the second end of the fourth capacitor, a gate terminal of the second N-type transistor is coupled to the second end of the first capacitor, and a body terminal of the second N-type transistor is coupled to a second end of the second resistor;
a third N-type transistor, wherein a source terminal of the third N-type transistor is coupled to the inter-stage input terminal, a drain terminal of the third N-type transistor is coupled to a second end of the second capacitor, and a gate terminal of the third N-type transistor is coupled to a second end of the fourth capacitor;
a fourth N-type transistor, wherein a source terminal of the fourth N-type transistor is coupled to the inter-stage input terminal, a drain terminal of the fourth N-type transistor is coupled to a second end of the fifth capacitor, and a gate terminal of the fourth N-type transistor is coupled to a second end of the first capacitor;
a fifth P-type transistor, wherein a source terminal of the fifth P-type transistor is coupled to an inter-stage output terminal which is coupled to a next rectifier circuit, a drain terminal of the fifth P-type transistor is coupled to the second end of the second capacitor, and a gate terminal of the fifth P-type transistor is coupled to a second end of the sixth capacitor;
a sixth P-type transistor, wherein a source terminal of the sixth P-type transistor is coupled to the inter-stage output terminal, a drain terminal of the sixth P-type transistor is coupled to the second end of the fifth capacitor, and a gate terminal of the sixth P-type transistor is coupled to a second end of the third capacitor;
a seventh P-type transistor, wherein a source terminal of the seventh P-type transistor is coupled to the inter-stage output terminal, a drain terminal of the seventh P-type transistor is coupled to the second end of the sixth capacitor, and a gate terminal of the seventh P-type transistor is coupled to the drain terminal of the seventh P-type transistor; and
an eighth P-type transistor, wherein a source terminal of the eighth P-type transistor is coupled to the inter-stage output terminal, a drain terminal of the eighth P-type transistor is coupled to the second end of the third capacitor, and a gate terminal of the eighth P-type transistor is coupled to the drain terminal of the eighth P-type transistor.

17. The WPT circuit of claim 1, wherein the control circuit comprises:
a voltage divider, configured to reduce a level of the DC output voltage to generate a divided output voltage;
a reference generator, configured to utilize the DC supply voltage as a power source and generate a comparator reference voltage and a bias voltage; and
a hysteresis comparator, coupled to the voltage divider and the reference generator, configured to utilize the DC supply voltage as a power source and determine whether the DC output voltage is increased to be greater than a first threshold level or whether the DC output voltage is decreased to be lower than a second threshold level according to the divided output voltage, the comparator reference voltage and the bias voltage, in order to generate the control signal, wherein the hysteresis comparator utilizes the DC supply voltage as a power source.

18. The WPT circuit of claim 17, wherein the voltage divider comprises multiple diode-connected transistors, a first portion of the multiple diode-connected transistors are coupled between a terminal receiving the DC output voltage and a terminal generating the divided output voltage, and a second portion of the multiple diode-connected transistors are coupled between the terminal generating the divided output voltage and a terminal receiving a reference voltage.

19. The WPT circuit of claim 17, wherein the hysteresis comparator comprises:
a first resistor, wherein a first end of the first resistor is configured to receive the divided output voltage;
a second resistor, wherein a first end of the second resistor is coupled to a second end of the first resistor; and
an amplifier, wherein a first input terminal of the amplifier is coupled to the second end of the first resistor, a second input terminal of the amplifier is configured to receive the comparator reference voltage, and an output terminal of the amplifier is coupled to a second end of the second resistor;
wherein a comparator input voltage is generated on the first input terminal according to the divided output voltage, the first resistor and the second resistor, and the amplifier is configured to control states of the control signal according to whether the comparator input voltage is greater than the comparator reference voltage.

20. The WPT circuit of claim 17, wherein:
when the DC output voltage is pulled up to be greater than the first threshold level, the control signal generated by the hysteresis comparator is switched to a first state from a second state;
when the DC output voltage is pulled down to be less than a second threshold level, the control signal generated by the hysteresis comparator is switched to the second state from the first state; and
the first threshold level is greater than the second threshold level.
